(19) United States
(12) Patent Application Publication
(10) Pub. No.: US 2011/0007030 A1
(43) Pub. Date: Jan. 13, 2011

(54) ULTRATHIN MUTUAL CAPACITANCE TOUCH SCREEN AND COMBINED ULTRATHIN TOUCH SCREEN

(76) Inventors: Michael Mo, Shenzhen (CN); JK Zhang, Shenzhen (CN)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/832,298

(22) Filed: Jul. 8, 2010

(30) Foreign Application Priority Data
Jul. 9, 2009 (CN) 200910157874.7

(51) Int. Cl. G06F 3/044

(52) U.S. Cl. 345/174

(57) ABSTRACT

Ultrathin mutual capacitance touch screen and combined ultrathin touch screen composed by the said ultrathin mutual capacitance touch screen, the said ultrathin mutual capacitance touch screen comprises driving electrode clusters and sensing electrode clusters, wherein the driving electrode clusters are connected with an excitation signal source arranged outside the touch screen, and the sensing electrode clusters are connected with a sensing control module arranged outside the touch screen. The driving electrode clusters comprise tabulate driving electrodes which are made of transparent conductive materials and connected in series and/or in parallel, and the sensing electrode clusters comprise tabulate sensing electrodes which are made of transparent conductive materials and connected in series and/or in parallel. In particular, in a pair of adjacent driving electrode and sensing electrode of the touch screen, the plate area of at least one electrode producing the eigen mutual electric field is smaller than that of the same electrode producing the variable mutual electric field. The present invention make the thickness of the touch screen become thinner, and ensure a higher effective capacitivity.

### TECHNICAL FIELD

The present invention relates to a touch sensing input device, in particular a touch input device using mutual capacitance as a sensing element.

### BACKGROUND ART

Touch screen is a widely used touch sensing input device. In accordance with the touch sensing principle, the touch screens of the prior art comprise resistive touch screens, capacitive touch screens, infrared surface touch screens and the like, wherein the resistive touch screens are popular for years because of the advantages of low cost, easy realization, simple control and the like. In recent years, capacitive touch screens become popular because of the advantages of high light transmittance, resistance to abrasion, resistance to ambient temperature change, resistance to ambient humidity change, long service life and good capability of realizing high and complex functions such as multipoint touch.

The sensing principle of change in capacitance is long-standing. In order to make the touch screen work effectively, a transparent capacitance sensor array is required. When human body or a special-purpose touch device such as a stylus gets close to the touch panel of the touch screen, the capacitance detected by the sensing control circuit can be changed, and the touch situation of the human body or the special-purpose touch device in the touch area can be judged in accordance with the distribution of capacitance value change in the touch area. In accordance with capacitance formation mode, the touch screens of the prior art comprise self-capacitance touch screens and mutual capacitance touch screens, wherein the self-capacitance touch screens use the changes of the capacitance formed by the sensing electrodes and AC or DC level electrodes as sensing signals; mutual capacitance touch screens use the changes of capacitance formed between two electrodes as touch sensing signals, and simultaneously use mutual capacitance as project capacitance.

As shown in FIG. 10, the mutual capacitance touch screen in the prior art comprise a touch panel 100′, driving wires 210′ and sensing wires 310′ which are not in the same plane, and a medium panel 910′ arranged between the driving wires 210′ and the sensing wires 310′. As shown in FIGS. 10-1 and 10-2, the driving wires 210′ are in parallel to each other, the sensing wires 310′ are also in parallel to each other, and the driving wires 210′ are spatially perpendicular to the sensing wires 310′. The driving wires 210′ is electrically connected with excitation signals, and the sensing wires 310′ are electrically connected with a sensing control circuit, thus, mutual capacitance is formed between the driving wires 210′ and the sensing wires 310′. The mutual capacitance C formed at the intersection of each driving wire 210′ and each sensing wire 310′ is the major capacitance data signal detected by the sensing control circuit. As shown in FIG. 10-3, the mutual capacitance C comprises capacitance C_{B} and C_{T}, wherein capacitance C_{B} is formed between the driving wire 210′ and the bottom of the sensing wire 310′, and capacitance C_{T} is formed between the driving wire 210′ and the top of the sensing wire 310′, namely that C_{B}+C_{T}. As shown in FIG. 10-4, when touching the touch panel 100′ with a finger 150′ within the touch area, the finger 150′ is equivalent to an electrode over the sensing wire 310′, and the electric field between the driving wire 210′ and the top of the sensing wire 310′ is changed; the change can be regarded as that the electric field lines from the driving wire 210′ to the sensing wire 310′ are attracted by the finger 150′, thus C_{T} is changed, and the mutual capacitance C is changed at the same time. The situation of the change of the mutual capacitance C in the whole touch area of the touch panel 100′ is detected by the sensing control circuit, so that the position and touching intensity of a touched point in the touch area can be determined. With rational design, the sensing control circuit can simultaneously detect the distribution situation of multipoint touch on the touch panel 100′ and can realize the function of sensing multipoint touch. The proportion of C_{T} change range in mutual capacitance C before touch is known as effective capacitivity.

With respect to a mutual capacitance touch screen in which the driving wires 210′ and the sensing wires 310′ are arranged in different layers, some methods and electrode arranging structures which can increase the effective capacitivity are provided in the prior art, however, in order to ensure an optimal effective capacitivity, at least hundreds of micron clearance are formed between respective planes of the driving wires 210′ and the sensing wires 310′, that is to say, a layered structure with the clearance is the precondition of increasing the effective capacitivity of the mutual capacitance touch screen of the prior art. Obviously, the layered structure of the mutual capacitance touch screen of the prior art has already become a restrictive factor for the development of touch screens towards ultrathin touch screens. If the driving wires 210′ and the sensing wires 310′ in the prior art are arranged in the same plane (namely the same layer), and necessary insulating treatment is performed to the driving wires 210′ and the sensing wires 310′, the requirements of developing ultrathin touch screens can be met, but the effective capacitivity is low, thus a complicated external control circuit is required. Furthermore, the electric field distribution of a monolayer touch screen is completely different from that of layered touch screen, thus the methods and structures in the prior art for increasing the effective capacitivity of the layered touch screen are no longer suitable for the monolayer touch screen, and a new method and/or structure need to be designed in order to solve the problem how to effectively increase the effective capacitivity in the monolayer mutual capacitance touch screen. In addition, the layered touch screen has the disadvantages of complicated manufacturing technique, high requirements for the location accuracy of the driving wires 210′ and the sensing wires 310′ and high requirements for production equipment, materials, technique and process, therefore, product cost is increased, and product yield is influenced to a certain extent.

### INVENTION CONTENTS

The technical problem the present invention aims to settle is to avoid the defects of the prior art to provide a monolayer ultrathin touch screen and combined touch screen with relative high effective capacitivity.

The present invention solves the technical problem by adopting the following technical schemes:

The present invention designs and manufactures an ultrathin mutual capacitance touch screen which comprises driving electrode clusters and sensing electrode clusters, wherein the driving electrode clusters are connected with an excitation signal source arranged outside the touch screen, and the sensing electrode clusters are connected with a sensing control module arranged outside the touch screen; the driving electrode clusters comprise tabulate driving electrodes which are made of transparent conductive materials and connected in series and/or in parallel, and the sensing electrode clusters comprise tabulate sensing electrodes which are made of transparent conductive materials and connected in series and/or in parallel. In particular, the driving electrode clusters and the sensing electrode clusters are arranged in the same plane, and the connecting wires of the electrode clusters cross each other without electrical contact, in addition, the driving electrodes and the sensing electrodes spread over the whole area of the touch screen in the same plane at intervals. Electric fields formed among the driving electrodes and the sensing electrodes comprise eigen mutual electric fields which cannot be changed due to the influence of external conductive electrodes and variable mutual electric fields which can be changed due to the influence of external conductive electrodes. In a pair of adjacent driving electrode and sensing electrode of the touch screen, the plate area of at least one electrode producing the eigen mutual electric field is smaller than that of the same electrode producing the variable mutual electric field.

Further, at least one hollow area is arranged in each electrode plate of the driving electrodes and/or the sensing electrodes.

In addition, the touch screen also comprises dummy electrode clusters, and the dummy electrode clusters comprise independent dummy electrodes which are made of transparent conductive materials and not electrically connected with each other; each dummy electrode is arranged in at least one of the clearance between a driving electrode and a sensing electrode, the hollow area in the driving electrode and the hollow area in the sensing electrode.

In order to further increase the effective capacitivity, the touch screen also comprises guard electrodes which are made of transparent conductive materials and electrically overhung, directly grounded or electrically connected with a DC power supply outside the touch screen. each guard electrode is arranged in at least one of the flat bottom area of the plane of the driving electrode clusters and the sensing electrode clusters, the clearance between a driving electrode and a sensing electrode, the hollow area in the driving electrode and the hollow area in the sensing electrode.

A cover plate made of transparent insulating materials is arranged on the top of the plane of the driving electrode clusters and the sensing electrode clusters. The bottom of the plane of the driving electrode clusters and the sensing electrode clusters is directly arranged on the top of an outside display screen or provided with a bottom plate.

The driving electrodes and the sensing electrodes are in rhombic, rectangular and hexagonal shapes.

The present invention still solves the technical problem by adopting the following technical schemes:

The present invention designs and manufactures a combined mutual capacitance touch screen which comprises a touch panel made of transparent material, particularly the combined ultrathin touch screen also comprises at least two mutual capacitance touch units which together fill the touch area of the touch panel. The mutual capacitance touch unit comprises the driving electrode clusters and the sensing electrode clusters, wherein the driving electrode clusters are electrically connected with the excitation signal source which is arranged outside the combined ultrathin touch screen and corresponds to the mutual capacitance touch unit, and the sensing electrode clusters are electrically connected with the sensing control module which is arranged outside the combined ultrathin touch screen and corresponds to the mutual capacitance touch unit. The driving electrode clusters comprise tabulate driving electrodes which are made of transparent conductive materials and connected in series and/or in parallel, and the sensing electrode clusters comprise tabulate sensing electrodes which are made of transparent conductive materials and connected in series and/or in parallel. The driving electrode clusters and the sensing electrode clusters are arranged in the same plane, and the connecting wires thereof cross each other without electrical contact; in addition, the driving electrodes and the sensing electrodes spread over the whole area of the touch screen in the same plane at intervals. Electric field formed between a driving electrode and a sensing electrode comprises an eigen mutual electric field which cannot be changed due to the influence of an external conductive electrode and a variable mutual electric fields which can be changed due to the influence of an external conductive electrode. In a pair of adjacent driving electrode and sensing electrode of the touch screen, the plate area of at least one electrode producing the eigen mutual electric field is smaller than that producing the variable mutual electric field.

Further, at least one hollow area is arranged in each electrode plate of the driving electrodes and/or the sensing electrodes.

The mutual capacitance touch units also comprises the dummy electrode clusters, and the dummy electrode clusters comprise independent dummy electrodes which are made of transparent conductive materials and not electrically connected with each other; each dummy electrode is arranged in at least one of the clearance between a driving electrode and a sensing electrode, the hollow area in the driving electrode and the hollow area in the sensing electrode.

The combined ultrathin touch screen also comprises connecting wires and lead wires of the guard electrodes, which are made of transparent conductive materials. The mutual capacitance touch units also comprise guard electrodes which are made of transparent conductive materials; each guard electrode is arranged in at least one of the flat area at the bottom of the plane of the driving electrode clusters and the sensing electrode clusters, the clearance between a driving electrode and a sensing electrode, the hollow area in the driving electrode and the hollow area in the sensing electrode. The guard electrodes are electrically suspended; or, the guard electrodes of each mutual capacitance touch unit are electrically connected with each other through the connecting wires of the guard electrodes and grounded through the lead wires of the guard electrodes or electrically connected with a DC power source outside the combined ultrathin mutual capacitance touch screen; or, the guard electrodes of each mutual capacitance touch unit are directly grounded through the lead wires of the guard electrodes or electrically connected with a DC power source outside the combined ultrathin mutual capacitance touch screen.

Compared with those in the prior art, the “ultrathin mutual capacitance touch screen and combined ultrathin touch screen” of the present invention have the technical effects that:

The touch screen of the present invention adopts a monolayer structure, namely that the driving electrode clusters equivalent to the driving wires of the prior art and the sensing electrode clusters equivalent to the sensing wires of the prior art are arranged in the same plane, thus the touch screen of the present invention is suitable for the trend of ultrathin touch screens. In the monolayer touch screen of the present invention, the intensity of the variable mutual electric fields is enhanced, while the intensity of the eigen mutual electric fields is decreased, and the proportion of the change range of the variable capacitance mainly influenced by variable mutual electric fields in the whole mutual capacitance is increased, namely that the effective capacitivity of the mutual capacitance in the touch screen is increased. The adoption of the dummy electrodes and the guard electrodes further enhances the advantages, and therefore further increases the effective capacitivity of the monolayer touch screen and simultaneously increases the touch resolution of the touch screen so as to make the light projecting rate of the touch screen nearly the same.

### DESCRIPTION OF FIGURES

FIG. 1 is the schematic diagram of the first preferred embodiment of the present invention, comprising:

FIG. 1-1 is the schematic diagram of electrode distribution of the first preferred embodiment;

FIG. 1-2 is the schematic diagram of electric field of the first preferred embodiment before the touch screen is touched;

FIG. 1-3 is the schematic diagram of electric field of the first preferred embodiment when the touch screen is touched;

FIG. 2 is the schematic diagram of electrode distribution of the second preferred embodiment of the present invention;

FIG. 3 is the schematic diagram of the third preferred embodiment of the present invention, comprising:

FIG. 3-1 is the schematic diagram of electrode distribution of the third preferred embodiment when hollow areas 130 are formed in driving electrodes 110;

FIG. 3-2 is the schematic diagram of electrode distribution of the third preferred embodiment when hollow areas 230 are formed in sensing electrodes 210;

FIG. 3-3 is the schematic diagram of electrode distribution of the third preferred embodiment when the hollow areas 130 of the driving electrodes and the hollow areas 230 of the sensing electrodes are respectively formed in the driving electrodes 110 and the sensing electrodes 210;

FIG. 4 is the schematic diagram of electrode distribution for the fourth preferred embodiment of the present invention;

FIG. 5 is the schematic diagram of the fifth preferred embodiment of the present invention, comprising:

FIG. 5-1 is the schematic diagram of electrode distribution of the fifth preferred embodiment;

FIG. 5-2 is the schematic diagram of electric field of the fifth preferred embodiment before the touch screen is touched;

FIG. 5-3 is the schematic diagram of electric field of the fifth preferred embodiment when the touch screen is touched;

FIG. 5-4 is the schematic diagram of electrode distribution shown in FIG. 3-1 after dummy electrodes 310 are added;

FIG. 6 is the schematic diagram of the sixth preferred embodiment of the invention, comprising:

FIG. 6-1 is schematic diagram of electric field of the sixth preferred embodiment before the touch screen is touched;

FIG. 6-2 is the schematic diagram of electric field of the sixth preferred embodiment when the touch screen is touched;

FIG. 7 is the schematic diagram of the seventh preferred embodiment of the present invention, comprising:

FIG. 7-1 is the schematic diagram of electric field of the seventh preferred embodiment before the touch screen is touched;

FIG. 7-2 is the schematic diagram of electric field of the seventh preferred embodiment when the touch screen is touched;

FIG. 7-3 is the schematic diagram of electrode distribution shown in FIG. 3-3 after dummy electrodes 310 and guard electrodes 400 are added;

FIG. 8 is the schematic diagram of connection for the eighth preferred embodiment of the invention;

FIG. 9 is the schematic diagram of electric field when driving electrodes 110″ and sensing electrodes 210″ in the prior art are arranged in the same plane;

FIG. 10 is the schematic diagram of the layered mutual capacitance touch screen in the prior art, comprising:

FIG. 10-1 is the schematic diagram of the general view for the orthographic projection of the touch screen;

FIG. 10-2 is the schematic diagram of the section view of FIG. 10-1 when viewing from the bottom;

FIG. 10-3 is the schematic diagram of electric field distribution before the touch screen is touched;

FIG. 10-4 is the schematic diagram of electric field distribution when the touch screen is touched.

### MODE OF CARRYING OUT THE INVENTION

All the preferred embodiments are further detailed as following in conjunction with figures.

As mentioned above, the driving wires and the sensing wires of the touch screen in the prior art form two opposite electrode plates of a capacitor. When the driving electrodes and the sensing electrodes are arranged in the same plane, the mutual electric fields among the driving electrodes and the sensing electrodes are totally different from that among the opposite electrodes of the touch screen in the prior art. As shown in FIG. 9, the mutual electric field between a driving electrode 110″ and a sensing electrode 210″ in the same plane comprise an eigen mutual electric field F_{B} which cannot be changed due to the influence of an external conductive electrode and a variable mutual electric field F_{V} which can be changed due to the influence of an external conductive electrode, and the two electric fields respectively form corresponding eigen capacitance C_{B} and variable capacitance C_{V} between the driving electrode and the sensing electrode; the mutual capacitance C between the driving electrode and the sensing electrode should meet: C=C_{B}+C_{V}, and the effective capacitivity is ΔC_{V}/C. The invention aims to decrease the eigen capacitance C_{B} and increase the variable capacitance C_{V}, namely enhance the variable mutual electric field F_{V} and weaken the eigen mutual electric field F_{B}.

The present invention relates to an ultrathin mutual capacitance touch screen which comprises driving electrode clusters 100 electrically connected with an excitation signal source 800 outside the touch screen and sensing electrode clusters 200 electrically connected with a sensing control module 900 outside the touch screen, wherein the driving electrode clusters 100 comprise tabulate driving electrodes 110 which are made of transparent conductive materials and connected with each other in series and/or in parallel, and the sensing electrode clusters 200 comprise tabulate sensing electrodes 210 which are made of transparent conductive materials and connected with each other in series and/or in parallel. In particular, the driving electrode clusters 100 and the sensing electrode clusters 200 are arranged in the same plane, and the connecting wires 120 and 220 thereof cross each other without electrical contact. In addition, the driving electrodes 110 and the sensing electrodes 210 spread over the whole area of the touch screen in the same plane at intervals. The electric field formed between a driving electrode 110 and a sensing electrode 210 comprises an eigen mutual electric field F_{B} which cannot be changed due to the influence of an external conductive electrode and a variable mutual electric field F_{V} which can be changed due to the influence of an external conductive electrode. In a pair of adjacent driving electrode 110 and sensing electrode 210 of the touch screen, the plate area of at least one electrode producing the eigen mutual electric field F_{B} is smaller than that of the same electrode producing the changeable mutual electric field F_{V}.

Generally, the eigen mutual electric field F_{B} is formed in the area where the driving electrode 110 and the sensing electrode 210 are close to each other, and the variable mutual electric field F_{V} is formed in other areas between the driving electrode 110 and the sensing electrode 210. In normal conditions, the intensity of the eigen mutual electric field F_{B} is larger than that of the variable mutual electric field F_{V}, and the intensity of the variable mutual electric field F_{V} can be larger than or equal to that of the eigen mutual electric field F_{B} only in the condition that the plate area of the eigen mutual electric field F_{B} is smaller than that of the variable mutual electric field F_{V}, therefore, the effective capacitivity of the touch screen is effectively increased.

The driving electrodes 110 as well as the sensing electrodes 210 are in rhombic, rectangular and hexagonal shapes. The shapes of the electrodes can not indicate the variety of the electrodes, and only the equipment connected with the electrodes determine the variety of the electrodes, namely the electrodes electrically connected with the excitation signal source 800 outside the touch screen are driving electrodes 110, and the electrodes electrically connected with the sensing control module 900 outside the touch screen are sensing electrodes 210.

The connecting wires 120 of the driving electrodes and the connecting wires 220 of the sensing electrodes cross each other without electrical contact and can be realized by the following methods: first, the driving electrode clusters 100 and the sensing electrode clusters 200 are arranged in the same plane and are on both surfaces of an ultrathin insulating plastic film, so that the connecting wires of the driving electrode clusters and the sensing electrode clusters spatially cross each other; second, insulation sheets are arranged at the intersections of the connecting wires 120 of the driving electrodes and the connecting wires 220 of the sensing electrodes so as to insulate the connecting wires 120 from 220.

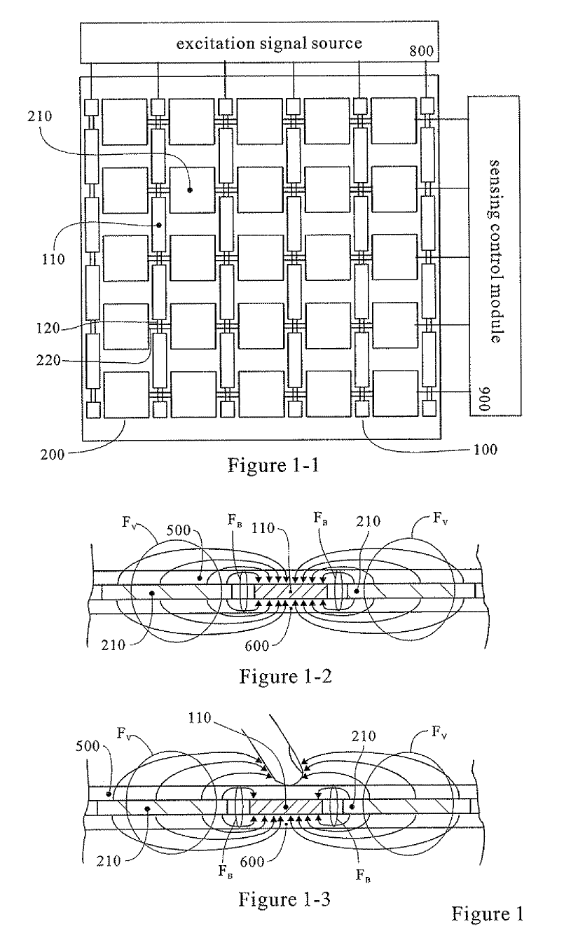

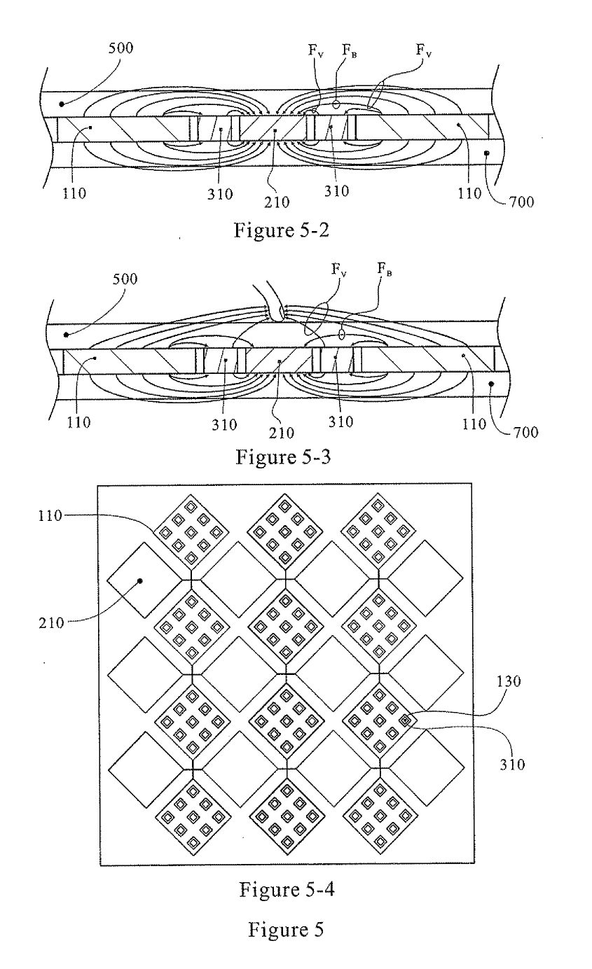

In addition, as shown in FIG. 1 and FIGS. 5 to 7, the touch screen also comprises a cover plate 500 which is made of transparent insulating materials and arranged on the top of the plane of the driving electrode clusters 100 and the sensing electrode clusters 200 to protect the electrode clusters and used as a touch plane for users. The bottom of the plane of the driving electrode clusters 100 and the sensing electrode clusters 200 can be directly arranged on the top of the outside display screen 600 (as shown in FIG. 1) and also provided with a bottom plate 700 (as shown in FIGS. 5 to 7).

In a pair of adjacent driving electrode 110 and sensing electrode 210 of the touch screen, the plate area of at least one electrode producing the eigen mutual electric field F_{B} is smaller than that of the same electrode producing the changeable mutual electric field F_{V}; many this kinds of structures are produced, and all structures are further described in the following embodiments:

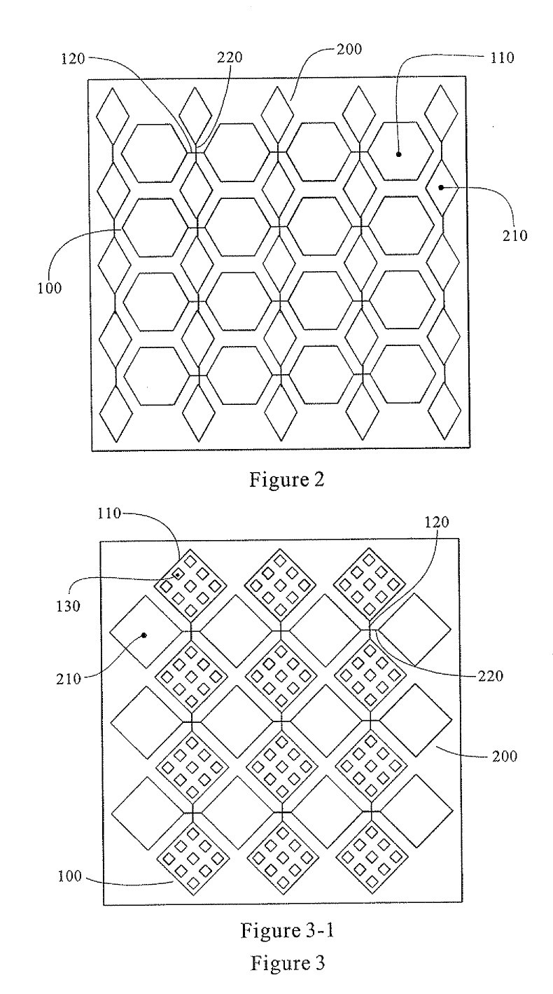

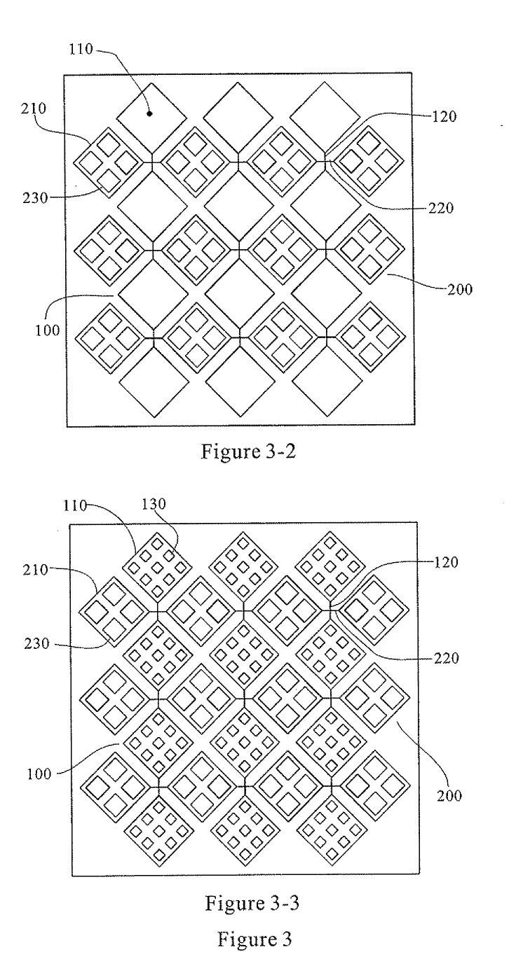

First structure, simply make the plate areas of a driving electrode 110 and a sensing electrode 210 different, so that the plate area producing the eigen mutual electric field F_{B} is smaller than that producing the changeable mutual electric field F_{V}. The first preferred embodiment of the present invention is shown in FIG. 1, the driving electrodes 110 and the sensing electrodes 210 are respectively in rectangular and square shapes, the plates of the driving electrodes 110 are in rectangular shape, the plates of the sensing electrodes 210 are in square shape, and the plate area of each sensing electrode 210 is obviously larger than that of each driving electrode 110. The electric field distributions of the first preferred embodiment before touch and after touch are respectively shown in FIG. 1-2 and FIG. 1-3, the difference of the plate areas causes that the plate area of the eigen mutual electric field F_{B} is smaller than that of the variable mutual electric field F_{V}, so that the intensity of the variable mutual electric field F_{V} is increased, the intensity of the eigen mutual electric field F_{B} is decreased, and the effective capacitivity of the touch screen is increased. The second preferred embodiment of the present invention is shown in FIG. 2, the plates of the driving electrodes 110 are in hexagonal shape, the plates of the sensing electrodes 210 are in rhombic shape, and the plate area of each sensing electrode 210 is obviously larger than that of each driving electrode 110. The electric field distribution of the second preferred embodiment is basically the same as that of the first preferred embodiment. The third preferred embodiment of the present invention is shown in FIG. 3-1, the plates of the driving electrodes 110 and the sensing electrodes 210 are all in square shape, at least one hollow area, namely the hollow area 130 in the driving electrode, is formed in the plate of each driving electrode 110 so as to make the plate area of each driving electrode 110 different form that of each sensing electrode 210. Accordingly, as shown in FIG. 3-2, at least one hollow area, namely the hollow area 230 of the sensing electrode, can be formed in the plate of each sensing electrode 210; as shown in 3-3, at least one hollow area, namely the hollow area 130 of the driving electrode and the hollow area 230 of the sensing electrode, is respectively formed in the plates of a driving electrode 110 and a sensing electrode 210. The electric field distribution of the third preferred embodiment is basically the same as that of the first preferred embodiment. From the view of electrode distribution, the driving electrodes 110 and the sensing electrodes 210 in the first preferred embodiment to the third preferred embodiment can be exchanged, namely the variety of an electrode is free from the influence of the plate area. Similarly, from the view of electrode distribution, the driving electrodes 110 and the sensing electrodes 210 in the following embodiments can also be exchanged.

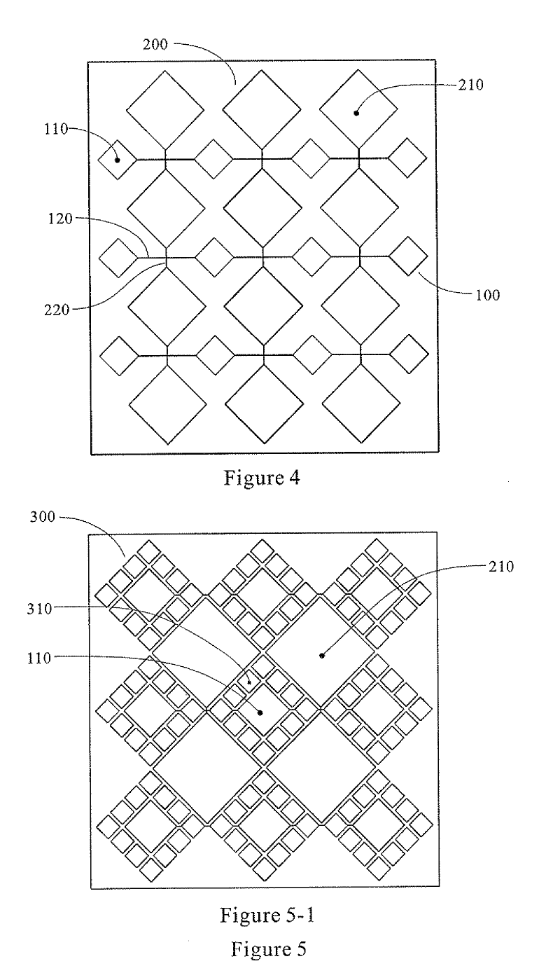

Second structure, the plate areas of the driving electrode 110 and the sensing electrode 210 are different, and a large clearance is formed between the driving electrode 110 and the sensing electrode 210. The fourth preferred embodiment of the present invention is shown in FIG. 4, each driving electrode 110 adopts a square plate with a small area, each sensing electrode 210 adopts a square plate with a large area, and a wide clearance is formed between the driving electrode 110 and the sensing electrode 210. The electric field distribution of the fourth preferred embodiment is the same as that of the first preferred embodiment, the distance between the plates of the driving electrode 110 and the sensing electrode 210 is enlarged due to the clearance; relative to the situation that no clearance is formed between the driving electrode and the sensing electrode, the clearance in the fourth preferred embodiment not only makes the plate area of the eigen mutual electric field F_{B} smaller, but also further decreases the intensity of the eigen mutual electric field F_{B} so as to increase the effective capacitivity of the touch screen.

Third structure, a dummy electrode is added so as to make the plate area of the eigen mutual electric field F_{B} smaller than that of the variable mutual electric field F_{V}. The touch screen of the invention also comprises dummy electrode clusters 300, wherein each dummy electrode cluster 300 comprises independent dummy electrodes 310 which are made of transparent conductive materials and free from electrical connection. On the basis of the fourth preferred embodiment, the fifth preferred embodiment of the present invention is shown in FIG. 5-1, the dummy electrodes 310 are respectively arranged in the clearance between the driving electrodes 110 and the sensing electrodes 210. The dummy electrodes 310 not only can improve the transmittance consistency of the touch screen, but also is of helpful to make the plate area of the eigen mutual electric field F_{B} smaller than that of the variable mutual electric field F_{V}. After the dummy electrodes 310 are added, the electric field distribution of the touch screen before touch and after touch are respectively shown in FIGS. 5-2 and 5-3; due to the dummy electrodes 310, more electric field lines emitted from the driving electrodes 110 reach the sensing electrodes 210 through the dummy electrodes 310. The electric field lines reaching the sensing electrodes 210 through the dummy electrodes 310 have poor stability and can be easily influenced by external electrodes, therefore, the electric field produced by each dummy electrode 310 should be a part of each variable mutual electric field F_{V}; almost all of the plate area of the dummy electrode 310 are used for producing the variable mutual electric field F_{V}, as a result, the plate area of the variable mutual electric field F_{V} is further enlarged due to the dummy electrode 310, and the effective capacitivity of the touch screen is further increased. Accordingly, the dummy electrode 310 can also be arranged in any other clearance of the touch screen, such as at least one of the hollow areas 130 and 230 respectively in the driving electrode 110 and the sensing electrode 210. As shown in 5-4, on the basis of the electrode distribution in the third preferred embodiment shown in FIG. 3-1 of the invention, the dummy electrodes 310 are arranged in the hollow areas 130 of the driving electrodes 110. On the basis of the electrode distribution in the third preferred embodiment shown in FIGS. 3-2 and 3-3 of the invention, the dummy electrodes 310 arranged in the hollow areas 130 of the driving electrodes and/or the hollow areas 230 of the sensing electrodes are obvious.

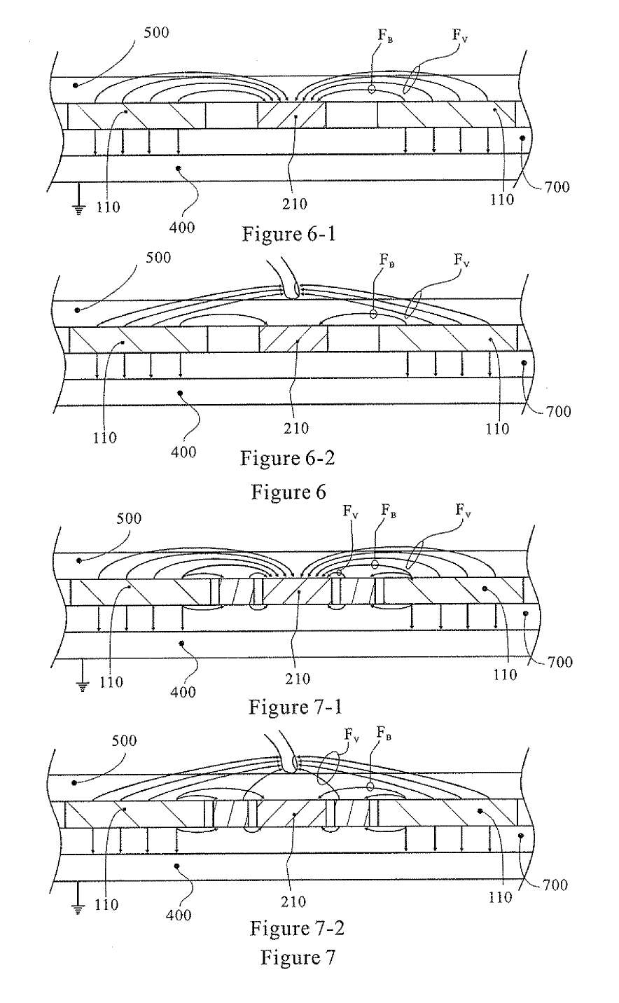

Fourth structure, guard electrodes are added so as to make the plate area of each eigen mutual electric field F_{B} smaller than that of each variable mutual electric field F_{V}. The invention also comprises guard electrodes 400 which are made of transparent conductive materials and are suspended, directly grounded or electrically connected with a DC power source outside the touch screen. As shown in FIG. 6, on the basis of the fourth preferred embodiment, the guard electrodes 400 are arranged on the bottom plane of the driving electrode clusters 100 and the sensing electrode clusters 200 in the sixth preferred embodiment of the present invention. Due to the guard electrodes 400, the electric field lines emitted from the driving electrodes 110 reach the guard electrodes 400 but not reach the sensing electrodes 210 so as to further reduce the plate area of the eigen mutual electric fields F_{B}, and therefore, the effective capacitivity of the touch screen is increased. In addition, the guard electrodes 400 can also be arranged in any other clearance, for example, on the basis of the third preferred embodiment of the present invention, the guard electrodes 400 are arranged in the clearance between the driving electrodes 110 and the sensing electrodes 210 and at least one of the hollow areas 130 and 230 respectively in the driving electrodes 110 and the sensing electrodes 210.

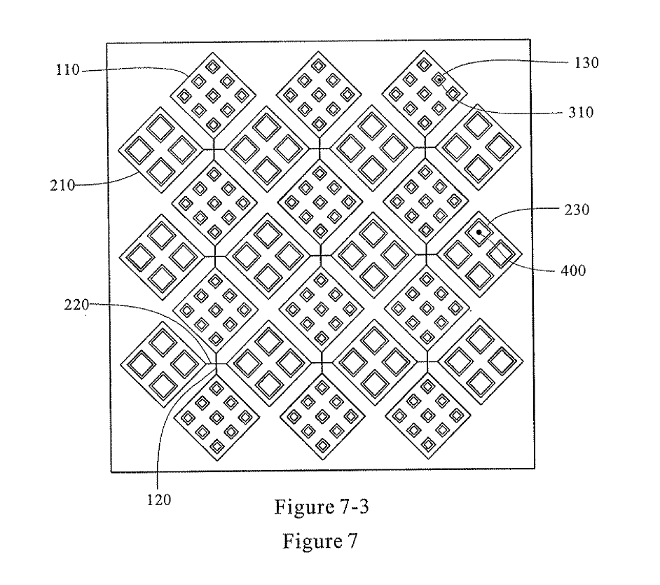

Fifth structure, the dummy electrodes and the guard electrodes are added simultaneously, which indirectly causes the plate area of each eigen mutual electric field F_{B} to be smaller than that of each variable mutual electric field F_{V}. The seventh preferred embodiment of the present invention is on the basis of the fourth preferred embodiment, all dummy electrodes 310 are arranged in the clearance between the driving electrodes 110 and the sensing electrodes 210, and simultaneously, the guard electrodes 400 are arranged on the bottom plane of the driving electrode clusters 100 and the sensing electrode clusters 200. The electric field distribution of the touch screen before touch and after touch in the seventh preferred embodiment of the present invention is respectively shown in FIGS. 7-1 and 7-2, under the action of the dummy electrodes 310 and the guard electrodes 400, the plate areas of the variable mutual electric field F_{V} and the eigen mutual electric field F_{B} are further enlarged, and therefore, the effective capacitivity of the touch screen is increased. As shown in FIG. 7-3, on the basis of the electrode distribution shown in FIG. 3-3 of the third preferred embodiment, the dummy electrodes 310 are arranged in the hollow areas 130 in the driving electrodes, and higher effective capacitivity can be also obtained by connecting the guard electrodes in series and/or in parallel. In addition, the method that the dummy electrodes 310 are arranged in the hollow areas 130 of the driving electrodes and the guard electrodes in serial connection and/or parallel connection are arranged in the hollow areas 230 of the sensing electrodes belongs to the normal condition of the fifth structure.

When the touch screen is used in the situation needing a large touch area, a single large touch screen can easily cause the resistance of the electrode clusters to be overhigh because of the overlength of the connecting wires 120 of the driving electrodes and the connecting wires 220 of the sensing electrodes, and as a result, the response effect of the touch screen is influenced. For solving the problem, the invention also relates to a combined ultrathin touch screen which comprises a transparent touch panel 2000, particularly, the touch screen also comprises at least two closely arranged mutual capacitance touch units 1000 covered by the touch panel, wherein the mutual capacitance touch units 1000 are together filled in the touch area of the touch panel. One touch unit is equivalent to one ultrathin mutual capacitance touch screen of the invention, therefore, the mutual capacitance touch unit 1000 comprises the driving electrode clusters 100 and the sensing electrode clusters 200, wherein the driving electrode clusters 100 are electrically connected with the excitation signal source 800 which is arranged outside the combined ultrathin touch screen and corresponds to the mutual capacitance touch unit 1000, and the sensing electrode clusters 200 are electrically connected with the sensing control module 900 which is arranged outside the combined ultrathin touch screen and corresponds to the mutual capacitance touch unit 1000. The driving electrode clusters 100 comprise the tabulate driving electrodes 110 which are made of transparent conductive materials and connected in series and/or in parallel, and the sensing electrode clusters 200 comprise the tabulate driving electrodes 210 which are made of transparent conductive materials and connected in series and/or in parallel. The driving electrode clusters 100 and the sensing electrode clusters 200 are arranged in the same plane, and the respective connecting wires 120 and 220 thereof cross each other without electric contact; in addition, the driving electrodes 110 and the sensing electrodes 210 in the same plane spread over the whole touch area of the touch screen at intervals; the electric field formed between a driving electrode 110 and the sensing electrode 210 comprises the eigen mutual electric field. F_{B} which cannot be changed due to the influence of an external conductive electrode and a changeable mutual electric field F_{V} which can be changed due to the influence of an external conductive electrode. In a pair of adjacent driving electrode 110 and sensing electrode 210 of the touch screen, the plate area of at least one electrode producing the eigen mutual electric field F_{B} is smaller than that of the same electrode producing the changeable mutual electric field F_{V}.

As mentioned above, at least one hollow area 130 and/or 230 is respectively arranged in the driving electrode 110 and/or the sensing electrode 210. The mutual capacitance touch units 1000 also comprise dummy electrode clusters 300 which comprise the independent dummy electrodes 310 free from electrical connection, wherein each dummy electrode 310 is arranged in at least one of the clearance between the driving electrode 110 and the sensing electrode 210, the hollow area 130 in the driving electrode and the hollow area 230 in the sensing electrode.

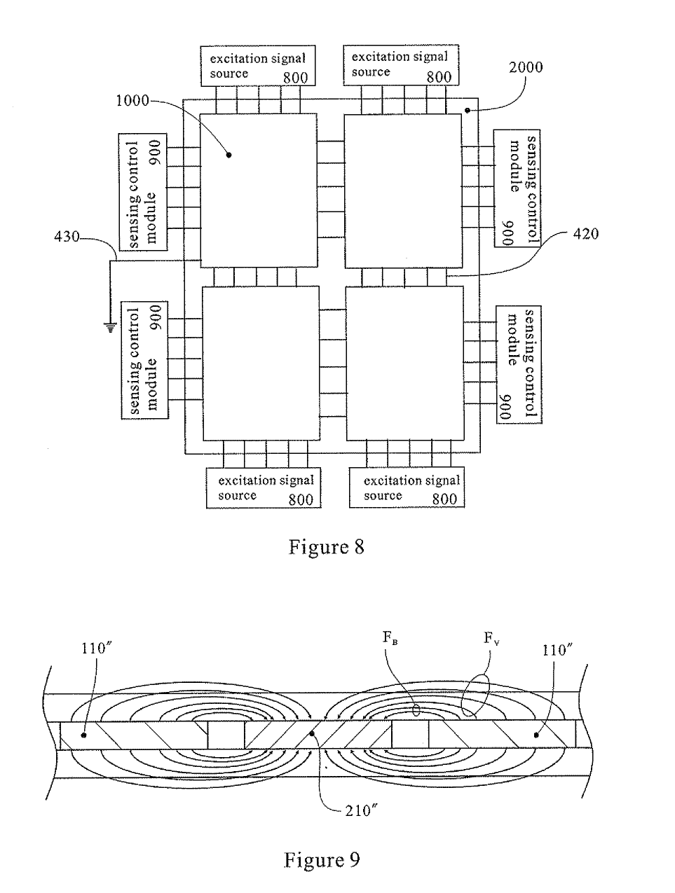

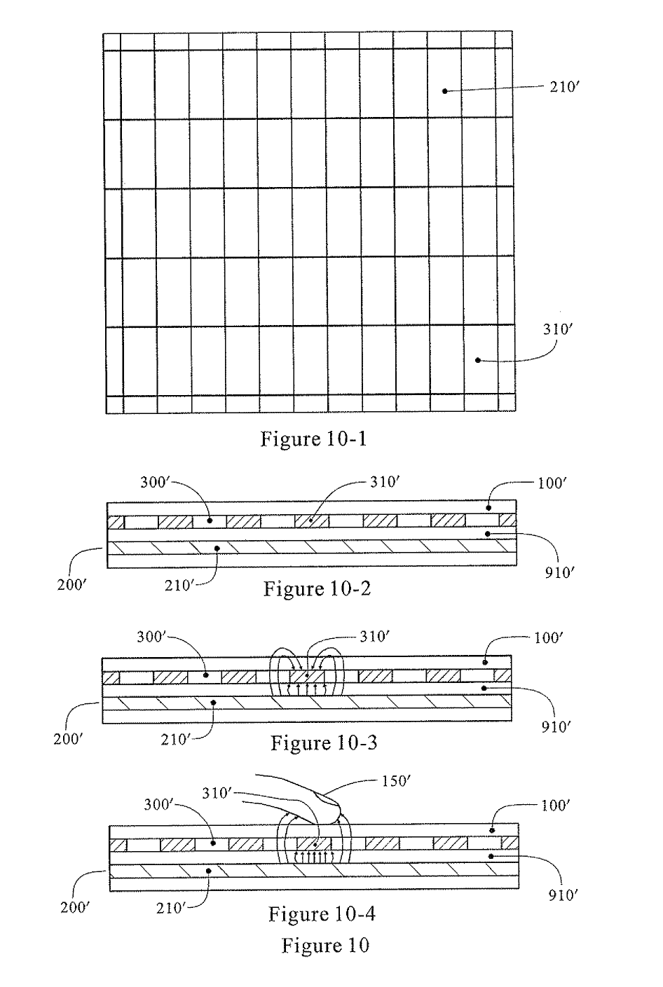

As shown in FIG. 8, the combined ultrathin touch screen also comprises the connecting wires 420 and the lead wires 430 of the guard electrodes, wherein the connecting wires are made of transparent conductive materials; the mutual capacitance touch units 1000 also comprise the guard electrodes 400 which are arranged in at least one of the flat bottom area of plane of the driving electrodes 110 and the sensing driving electrodes 210, the clearance between the driving electrodes 110 and the sensing electrodes 210, the hollow area 130 in the driving electrodes and the hollow area 230 in the sensing electrodes. The guard electrodes 400 are electrically suspended; or, the guard electrodes 400 of the mutual capacitance touch units 1000 are electrically connected through the connecting wires 420 of the guard electrodes and grounded through the lead wires 430 of the guard electrodes or electrically connected with the DC power source outside the combined ultrathin mutual capacitance touch screen; or, the guard electrodes 400 of the mutual capacitance touch units 1000 are directly grounded through the lead wires 430 of the guard electrodes or electrically connected with the DC power source outside the combined ultrathin mutual capacitance touch screen.

The electrode distribution of the ultrathin touch screen in any embodiment is suitable for the mutual capacitance touch units 1000 but is not limited to this. The mutual capacitance touch units 1000 all meet the requirement that in a pair of adjacent driving electrode 110 and sensing electrode 210 of the touch screen, the plate area of at least one electrode producing the eigen mutual electric field F_{B} is smaller than that of the same electrode producing the changeable mutual electric field F_{V} so as to obtain favorable effective capacitivity.

The transparent conductive materials for making the driving electrodes 110, the sensing electrodes 210, the dummy electrodes 310, the guard electrodes 400 and the connecting wires of the guard electrodes comprise Indium Tin Oxide (ITO for short) and Antimony Tin Oxide (ATO for short).

1. An ultrathin mutual capacitance touch screen comprises driving electrode clusters and sensing electrode clusters, wherein the driving electrode clusters are connected with an excitation signal source arranged outside the touch screen, and the sensing electrode clusters are connected with a sensing control module arranged outside the touch screen; the driving electrode clusters comprise tabulate driving electrodes which are made of transparent conductive materials and connected in series and/or in parallel, and the sensing electrode clusters comprise tabulate sensing electrodes which are made of transparent conductive materials and connected in series and/or in parallel; The ultrathin mutual capacitance touch screen is characterized in that:
The driving electrode clusters and the sensing electrode clusters are arranged in the same plane, and the connecting wires thereof cross each other without electrical contact; in addition, the driving electrodes and the sensing electrodes spread over the whole area of the touch screen in the same plane at intervals;
Electric fields formed between a driving electrode and a sensing electrode comprises an eigen mutual electric field which cannot be changed due to the influence of an external conductive electrode and a variable mutual electric fields which can be changed due to the influence of an external conductive electrode; In a pair of adjacent driving electrode and sensing electrode of the touch screen, the plate area of at least one electrode producing the eigen mutual electric field is smaller than that of the same electrode producing the variable mutual electric field.

2. The ultrathin mutual capacitance touch screen according to claim 1 is characterized in that:
At least one hollow area is arranged in each electrode plate of the driving electrodes and/or the sensing electrodes.

3. The ultrathin mutual capacitance touch screen according to claim 1 is characterized in that:
The touch screen also comprises dummy electrode clusters, and the dummy electrode clusters comprise independent dummy electrodes which are made of transparent conductive materials and not electrically connected with each other; each dummy electrode is arranged in at least one of the clearance between a driving electrode and a sensing electrode, the hollow area in the driving electrode and the hollow area in the sensing electrode.

4. The ultrathin mutual capacitance touch screen according to claim 1 is characterized in that:
The touch screen also comprises guard electrodes which are made of transparent conductive materials and electrically overhung, directly grounded or electrically connected with a DC power supply outside the touch screen; each guard electrode is arranged in at least one of the flat bottom area of the plane of the driving electrode clusters and the sensing electrode clusters, the clearance between a driving electrode and a sensing electrode, the hollow area in the driving electrode and the hollow area in the sensing electrode.

5. The ultrathin mutual capacitance touch screen according to claim 1 is characterized in that:
A cover plate made of transparent insulating materials is arranged on the top of the plane of the driving electrode clusters and the sensing electrode clusters; the bottom of the plane of the driving electrode clusters and the sensing electrode clusters is directly arranged on the top of an outside display screen or provided with a bottom plate.

6. The ultrathin mutual capacitance touch screen according to claim 1 is characterized in that:
The driving electrodes and the sensing electrodes are in rhombic, rectangular and hexagonal shapes.

7. A combined ultrathin touch screen which comprises a touch panel made of transparent materials and is characterized in that:
The combined ultrathin touch screen also comprises at least two mutual capacitance touch units which together fill the touch area of the touch panel;
The mutual capacitance touch units comprise the driving electrode clusters and the sensing electrode clusters, wherein the driving electrode clusters are electrically connected with the excitation signal source which is arranged outside the combined ultrathin touch screen and corresponds to the mutual capacitance touch units, and the sensing electrode clusters are electrically connected with the sensing control module which is arranged outside the combined ultrathin touch screen and corresponds to the mutual capacitance touch units; the driving electrode clusters comprise tabulate driving electrodes which are made of transparent conductive materials and connected in series and/or in parallel, and the sensing electrode clusters comprise tabulate sensing electrodes which are made of transparent conductive materials and connected in series and/or in parallel;
The driving electrode clusters and the sensing electrode clusters are arranged in the same plane, and the connecting wires thereof cross each other without electrical contact; in addition, the driving electrodes and the sensing electrodes spread over the whole area of the touch screen in the same plane at intervals;
Electric field formed between a driving electrode and a sensing electrode comprises an eigen mutual electric field which cannot be changed due to the influence of an external conductive electrode and a variable mutual electric fields which can be changed due to the influence of an external conductive electrode; In a pair of adjacent driving electrode and sensing electrode of the touch screen, the plate area of at least one electrode producing the eigen mutual electric field is smaller than that producing the variable mutual electric field.

8. The combined ultrathin touch screen according to claim 7 is characterized in that:
At least one hollow area is arranged in each electrode plate of the driving electrodes and/or the sensing electrodes.

9. The combined ultrathin touch screen according to claim 7 is characterized in that:
The mutual capacitance touch units also comprises the dummy electrode clusters, and the dummy electrode clusters comprise independent dummy electrodes which are made of transparent conductive materials and not electrically connected with each other; each dummy electrode is arranged in at least one of the clearance between a driving electrode and a sensing electrode, the hollow area in the driving electrode and the hollow area in the sensing electrode.

10. The combined ultrathin touch screen according to claim 7 is characterized in that:
The combined ultrathin touch screen also comprises connecting wires and lead wires of the guard electrodes, which are made of transparent conductive materials;
The mutual capacitance touch units also comprise guard electrodes which are made of transparent conductive materials; each guard electrode is arranged in at least one of the flat area at the bottom of the plane of the driving electrode clusters and the sensing electrode clusters, the clearance between a driving electrode and a sensing electrode, the hollow area in the driving electrode and the hollow area in the sensing electrode;
The guard electrodes are electrically suspended; or, the guard electrodes of each mutual capacitance touch unit are electrically connected with each other through the connecting wires of the guard electrodes and grounded through the lead wires of the guard electrodes or electrically connected with a DC power source outside the combined ultrathin mutual capacitance touch screen; or, the guard electrodes of each mutual capacitance touch unit are directly grounded through the lead wires of the guard electrodes or electrically connected with a DC power source outside the combined ultrathin mutual capacitance touch screen.
